(19) United States
(12) Patent Application Publication
(10) Pub. No.: US 2015/0278605 A1
(43) Pub. Date: Oct. 1, 2015

(54) APPARATUS AND METHOD FOR MANAGING REPRESENTATIVE VIDEO IMAGES

(71) Applicant: Electronics and Telecommunications Research Institute, Daejeon (KR)

(72) Inventors: Yong Seok SEO, Daejeon (KR); Jung Hyun KIM, Daejeon (KR); Jee Hyun PARK, Daejeon (KR); Young Suk YOON, Chungcheongbuk-do (KR); Won Young YOO, Daejeon (KR); Young Ho SUH, Daejeon (KR); Wook Ho SON, Daejeon (KR)

(21) Appl. No.: 14/598,136

(22) Filed: Jan. 15, 2015

(30) Foreign Application Priority Data
Mar. 28, 2014 (KR) 10-2014-0036932

(51) Int. Cl. G06K 9/00; G06K 9/46

(52) U.S. Cl. CPC G06K 9/00711; G06K 9/4604

(57) ABSTRACT

An apparatus and method for managing a representative video image, which selects representative images based on human visual aesthetic criteria and creates an album by arranging the selected representative images in an album template with various layouts, based on the region of interest (ROI).

### CROSS-REFERENCE TO RELATED APPLICATION(S)

This application claims priority from Korean Patent Application No. 10-2014-0036932, filed on Mar. 28, 2014, in the Korean Intellectual Property Office, the disclosure of which is incorporated herein by reference in its entirety.

### BACKGROUND

1. Field

The following description relates to image management, and more particularly, to an apparatus and method for managing a representative video image.

2. Description of the Related Art

With the diversification of devices for video production and the increase of easy access to video data via wired/wireless networks, there is growing demand for sharing video summary information or converting videos into a photo album.

As described in Korean Patent Publication No. 10-2013-0061058 (published on Jun. 10, 2013), most of the existing methods for summarizing a video use a small number of key frames to represent a long video clip and, among the key frames, further group or cluster key frames with high similarity.

Unlike the existing methods, an apparatus and method described herein determine representative images of a video based on human aesthetic criteria, and automatically arrange the images in a previously stored layout template.

### SUMMARY

The following description relates to an apparatus for managing a representative video image, including: a shot identifier configured to divide a video image into shot groups; a representative image extractor configured to extract a representative image from each of the shot groups generated by the shot identifier; and a region of interest (ROI) extractor configured to generate ROI images for each of the shot groups by editing the extracted representative image of each of the shot groups, focusing on an ROI within the representative image of each of the shot groups.

The apparatus may further include an album creator configured to create an album by arranging the extracted ROI images for each of the shot groups in an album template.

The shot identifier may be configured to analyze a correlation between image characteristics of neighboring video frames, and classify neighboring shots determined to be correlated with each other into a shot group.

The correlation between image characteristics of the neighboring video frames may be at least one of differences in brightness information, contour information, motion information, and feature point information.

The representative image extractor may be configured to extract the representative image of each of the shot groups based on aesthetic criteria.

The aesthetic criteria may be video frame information about at least one of a composition of a video frame, a color, luminance distribution, contrast, contour distribution, or blur information.

The album creator may be configured to automatically arrange the ROI images of each of the shot groups in a layout area of a particular album template chosen from a plurality of previously stored album templates with different layouts.

The ROI extractor may be configured to identify a position of a main subject as an ROI within the representative image, and extract the ROI image by trimming an area including the main subject to a size of a layout area in which the representative image is disposed.

The album creator may be configured to keep a record in the album about video shooting date and time information.

The album creator may be configured to further record information about a video shooting location.

In another general aspect, there is provided a method of managing a representative video image, including: dividing a video image into shot groups; extracting a representative image from each of the shot groups; and generating region-of-interest (ROI) images for each of the shot groups by editing the extracted representative image of each of the shot groups, focusing on an ROI within the representative image of each of the shot groups.

The method may further include creating an album by arranging the extracted ROI images for each of the shot groups in an album template.

Other features and aspects will be apparent from the following detailed description, the drawings, and the claims.

### BRIEF DESCRIPTION OF THE DRAWINGS

FIG. 1 is a diagram illustrating a configuration of an apparatus for managing a representative video image according to an exemplary embodiment.

FIG. 2 is a diagram illustrating procedures for managing a representative image of the apparatus of FIG. 1.

FIG. 3 is a diagram illustrating an example of a shot identifier of the apparatus of FIG. 1.

FIG. 4 is a graph illustrating an example of luminance histogram.

FIG. 5 is a diagram illustrating an example of contour detection.

FIG. 6 is a diagram illustrating an example of trimming an area including a main subject as a region of interest (ROI) within a representative image.

FIG. 7 is a diagram illustrating examples of album templates with different layouts.

FIG. 8 is a diagram illustrating examples of arrangement in an album template based on an ROI.

FIG. 9 is a flowchart illustrating a method for managing a representative video image according to an exemplary embodiment.

FIG. 10 is an embodiment of the present invention may be implemented in a computer system.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

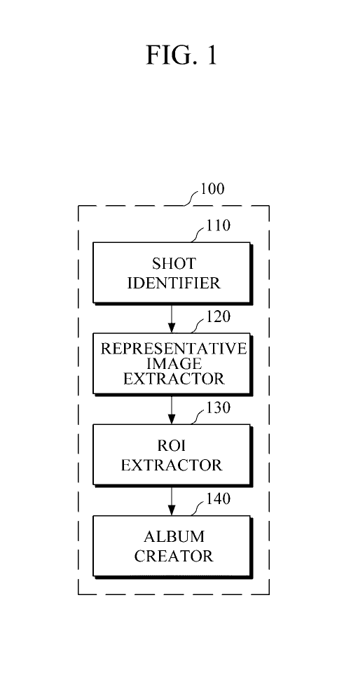

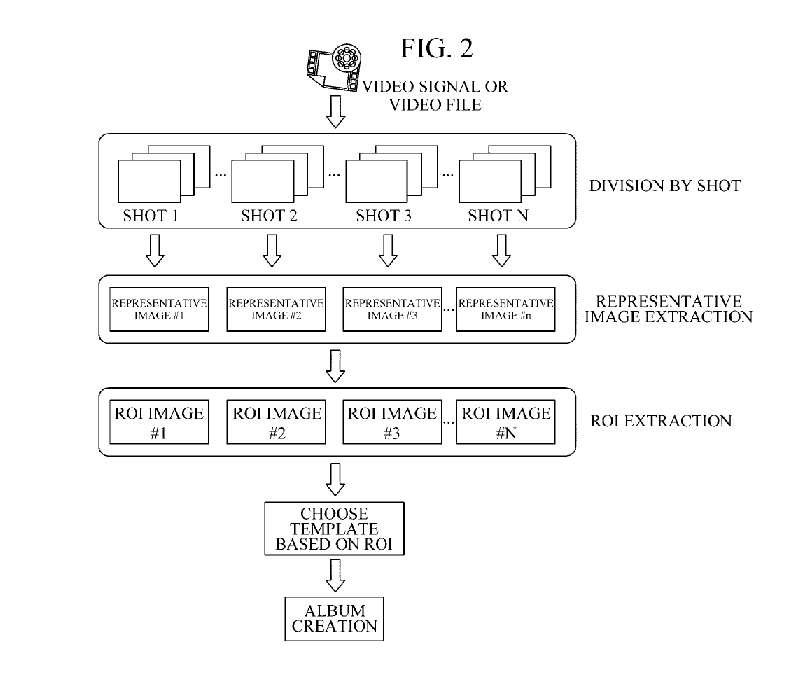

FIG. 1 is a diagram illustrating a configuration of an apparatus for managing a representative video image according to an exemplary embodiment. FIG. 2 is a diagram illustrating procedures for managing a representative image of the apparatus of FIG. 1.

The apparatus 100 for managing a representative video image may be implemented as hardware or software to be equipped in an electronic device, such as a personal computer (PC) and a smartphone, or as the combination of hardware and software. The apparatus 100 may include a shot-identifier 110, a representative image extractor 120, and a region of interest (ROI) extractor 130.

The shot identifier 110 may divide a video image into shot groups. For example, the shot identifier 110 may analyze a correlation between image characteristics of neighboring video frames and classify neighboring shots determined to be correlated with each other into the same shot group.

In this case, a correlation between image characteristics of the neighboring video frames may be at least one of differences in brightness information, contour information, motion information, and feature point information.

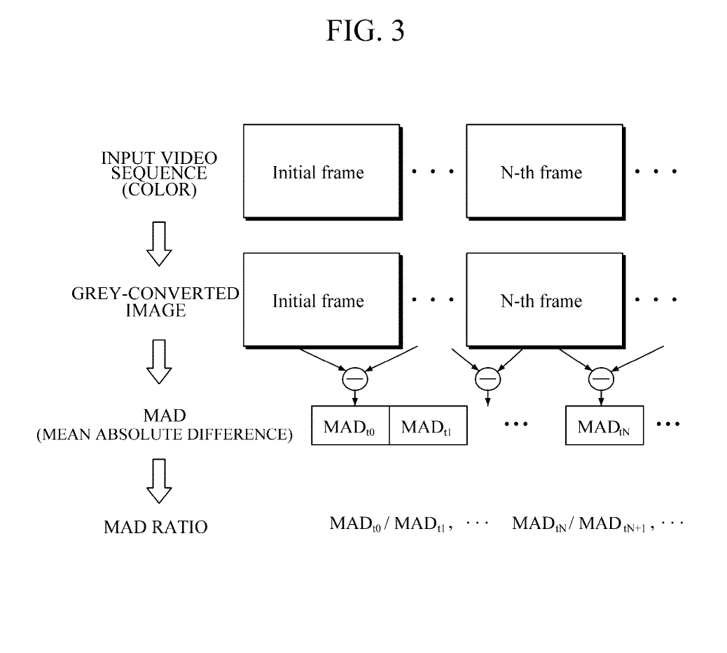

For example, as shown in FIG. 3, input video sequences (color) are converted to gray images, and then a mean absolute difference (MAD) of pixel values of neighboring frames is calculated. When the MAD ratio between a previous frame and a current frame is greater than a previously set threshold, the current frame may be determined as a starting frame of a new shot.

In this case, for MAD operation reduction, MAD calculation may be restricted to a particular region of a frame, input video frame size may be reduced, or the MAD calculation may be performed on a particular bit plane.

The representative image extractor 120 extracts a representative image from each shot group generated by the shot identifier 110. In this case, the representative image extractor 120 may extract a representative image from each shot group based on aesthetic criteria. The aesthetic criteria may be video frame information about at least one of a composition of a video frame, a color, luminance distribution, contrast, contour distribution, or blur information.

For example, in using composition information, an image statistical principle that a subject positioned on an intersection of a 3×3 grid on an image makes the image look balanced and aesthetically beautiful is used.

For example, in using color information, an image statistical principle is used that an aesthetically beautiful image has simple colors and relatively high saturation and luminance values when color in HSV color space is represented as hue, saturation and value (luminance) (HSV) components. The monotony of color of an image may be determined by calculating the number of histograms appearing more than a predetermined frequency threshold, where the histogram represents the distribution of hue values. As the number of histograms decreases, the image may be determined to be more aesthetically beautiful.

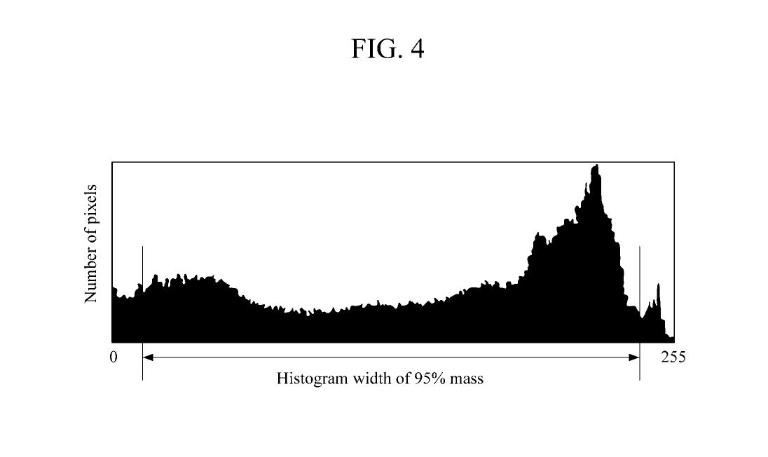

For example, in using luminance distribution, an image statistical principle is used that as luminance distribution of an image falls within a narrower range, the image is simpler and more authentically beautiful. For example, as shown in FIG. 4, the aesthetic value may be evaluated by calculating a luminance histogram width that accounts for 95% of luminance histogram area.

For example, in using a contrast ratio, an image statistical principle that an aesthetically beautiful image has a high contrast ratio is used. A contrast ratio is determined as being higher when a calculated Michelson or Root Mean Square (RMS) value is greater. Michelson and RMS may be calculated as below:

$$Michelson = \frac{{L}_{max} - {L}_{min}}{{L}_{min} + {L}_{min}}$$

$$RMS = {[ \frac{1}{N - 1} {\sum }_{k = 1}^{N} {( {L}_{k} - {L}_{avg} )}^{2} ]}^{\frac{1}{2}} ,$$

where Lₘₐₓ represents a maximum luminance value, Lₘᵢₙ represents a minimum luminance value, and L_{avg} represents an average luminance value.

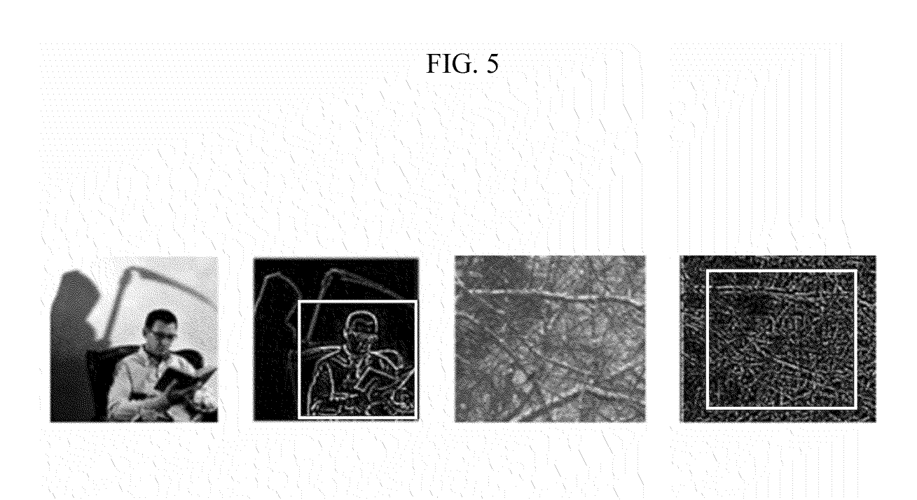

For example, in a case where contour distribution is used as an aesthetic criterion, an area ratio of a particular part of the entire image is calculated where the particular part accounts for more than a specific percentage of contour energy within the image. A smaller area ratio indicates that a theme of the image is represented in a concentrated way, and such image is statistically regarded as being aesthetically beautiful. The image contour may be easily detected using the Laplacian filter and the like. For example, the contour detection may be performed as shown in FIG. 5.

For example, the use of blur information allows for removing blurred image frames, so that the relevant characteristics can be used to select a representative image from each shot group. A degree of blurring of an image may be employed to select a representative image by measuring the amount of high frequency components in the image using frequency transformation, such as a fast Fourier transform (FFT) or wavelet transform.

The ROI extractor 130 generates ROI images for each shot group by editing the representative image of each shot group that has been extracted by the representative image extractor 120, focusing on an ROI.

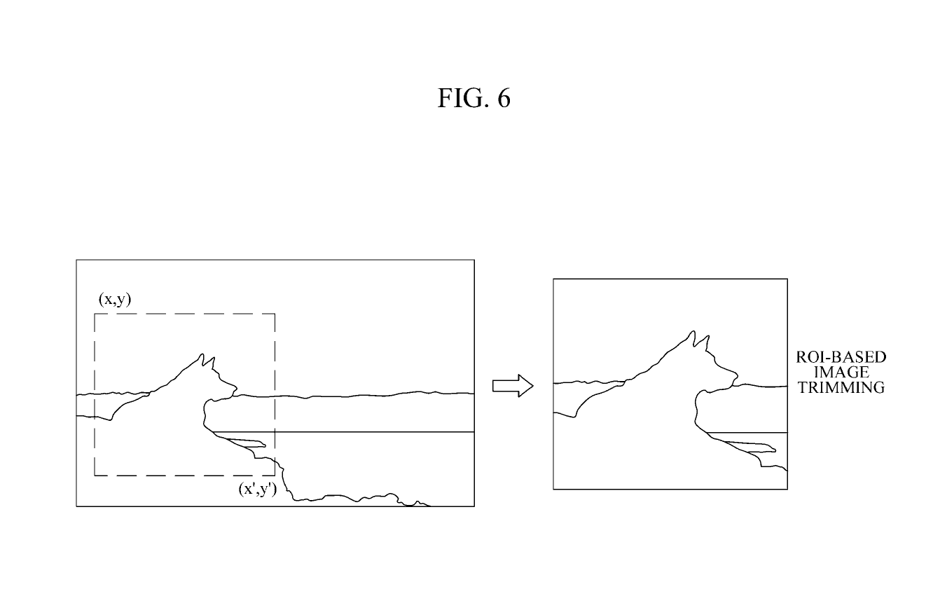

For example, as shown in FIG. 6, the ROI extractor 130 may be configured to extract an ROI image by identifying a position of a main subject as an ROI within the representative image, and trimming a region including the main subject to a size of a layout area in which the representative image is disposed. FIG. 6 is a diagram illustrating an example of trimming an area including a main subject as an ROI within a representative image.

Therefore, it may be possible to select a representative image based on human visible aesthetic criteria, and extract an ROI image from the representative image, which enables the video content made by an individual user to be freely shared and easily printed, thereby increasing user convenience and utilization of video.

In another example, the apparatus 100 may further include an album creator 140. The album creator 140 may create an album by arranging the ROI images of each shot group that have been extracted by the ROI extractor 130, in an album template.

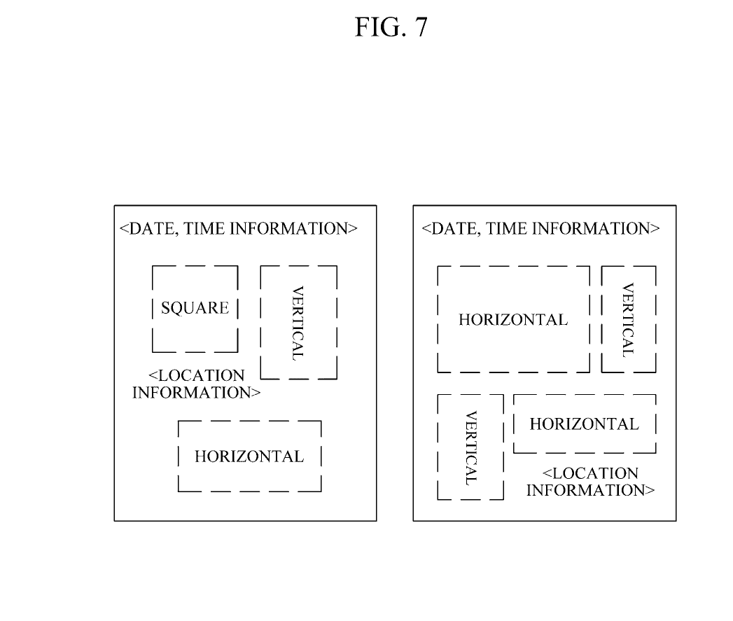

The album creator 140 may be configured to automatically arrange the ROI images of each shot group in a layout area of a particular album template chosen from a plurality of previously stored album templates with different layouts, as shown in FIG. 7. FIG. 7 is a diagram illustrating examples of album templates with different layouts.

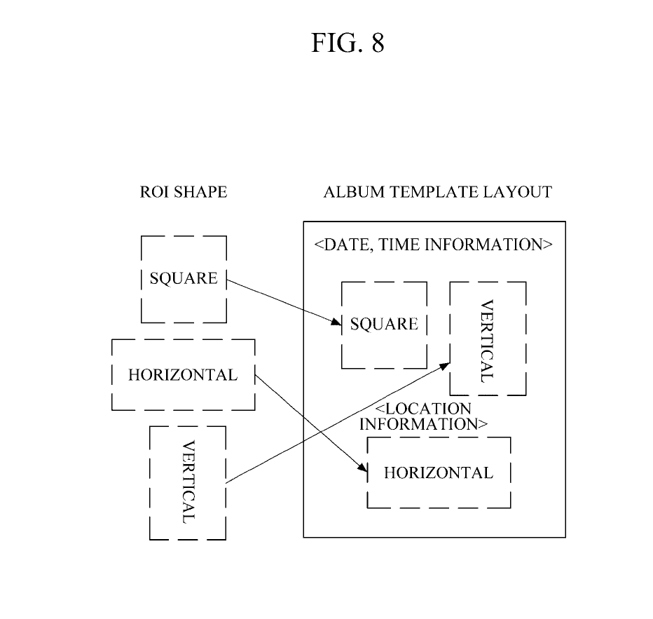

As shown in FIG. 8, the album creator 140 may be configured to select an album template with an appropriate layout for the ROI images of each shot group extracted by the ROI extractor 130 from among the plurality of album templates according to the shape of the ROI images, and arrange the ROI images in the layout of the selected album template.

In another example, the album creator 140 may be configured to keep a record in the album about video shooting date and time information. In addition, the album creator 140 may be configured to further record information about the video shooting location. In this example, the video shooting date and time information, the video shooting location information, and the like, may be known from meta-information of a video file.

By implementing the apparatus as above, representative images that satisfy the human aesthetic criteria are determined from a video file, and an album including ROI images extracted from the determined representative images is created, so that it is possible to freely share the video content made by an individual user with other users and easily print an image of the video content, thereby increasing user convenience and utilization of video.

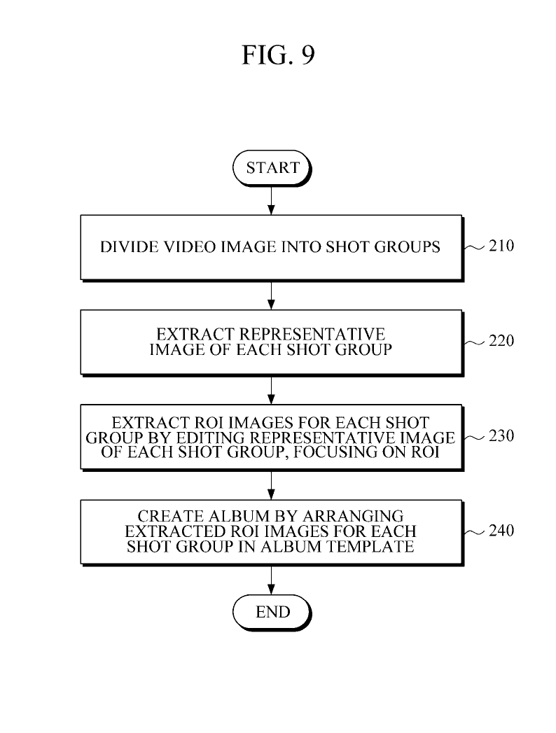

Operations of an image for managing a representative video image according to the above exemplary embodiments will be described with reference to FIG. 9. FIG. 9 is a flowchart illustrating a method for managing a representative video image according to an exemplary embodiment.

In 210, the apparatus may divide a video image into shot groups. The operation of dividing the video image into shot groups is described above, and thus the detailed description thereof will not be reiterated.

Then, in 220, the apparatus extracts a representative image from each shot group. The extraction of a representative image from each shot group is described above, and thus the detailed description thereof will not be reiterated.

Then, in 230, the apparatus extracts ROI images for each shot group by editing the extracted representative image of each shot group, focusing on an ROI. The extraction of the ROI images for each shot group is described above, and thus the detailed description thereof will not be reiterated.

In 240, the apparatus creates an album by arranging the extracted ROI images for each shot group in an album template. The album template is described above, and thus the detailed description thereof will not be reiterated.

As described above, representative images that satisfy the human visual aesthetic criteria are determined from a video file, and an album is created using ROI images extracted from the determined representative images, so that it becomes possible to freely share the video content made by an individual user with other users and easily print a photo from a video, thereby increasing user convenience and utilization of video.

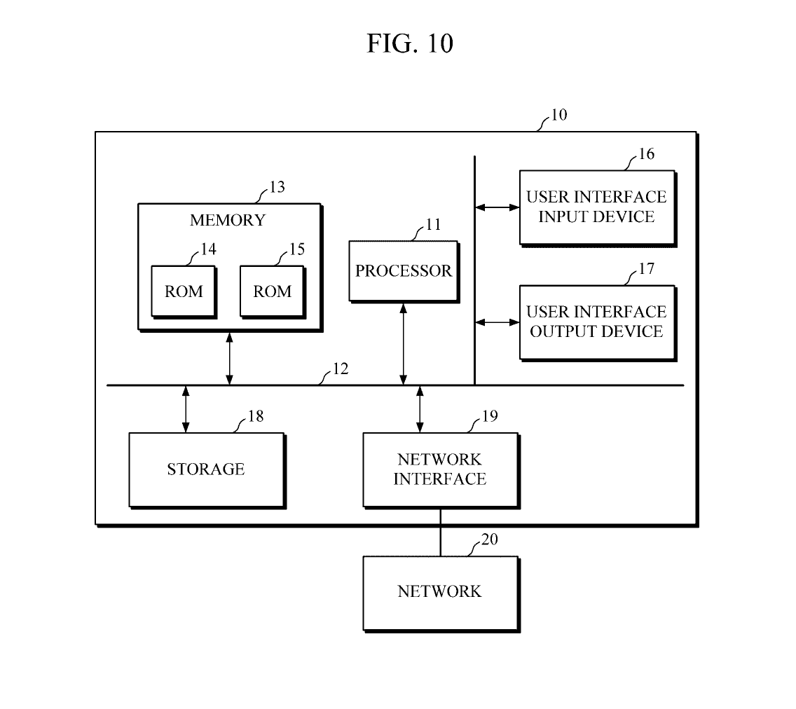

FIG. 10 is an embodiment of the present invention may be implemented in a computer system, e.g., as a computer readable medium. As shown in FIG. 10, a computer system 10 may include one or more of a processor 11, a memory 13, a user input device 16, a user output device 17, and a storage 18, each of which communicates through a bus 12. The computer system 10 may also include a network interface 19 that is coupled to a network 20. The processor 11 may be a central processing unit (CPU) or a semiconductor device that executes processing instructions stored in the memory 13 and/or the storage 18. The memory 13 and the storage 18 may include various forms of volatile or non-volatile storage media. For example, the memory may include a read-only memory (ROM) 14 and a random access memory (RAM) 15.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for managing a representative video image, comprising:
a shot identifier configured to divide a video image into shot groups;
a representative image extractor configured to extract a representative image from each of the shot groups generated by the shot identifier; and
a region of interest (ROI) extractor configured to generate ROI images for each of the shot groups by editing the extracted representative image of each of the shot groups, focusing on an ROI within the representative image of each of the shot groups.

2. The apparatus of claim 1, further comprising:
an album creator configured to create an album by arranging the extracted ROI images for each of the shot groups in an album template.

3. The apparatus of claim 1, wherein the shot identifier is configured to analyze a correlation between image characteristics of neighboring video frames, and classify neighboring shots determined to be correlated with each other into a shot group.

4. The apparatus of claim 3, wherein the correlation between image characteristics of the neighboring video frames is at least one of differences in brightness information, contour information, motion information, and feature point information.

5. The apparatus of claim 1, wherein the representative image extractor is configured to extract the representative image of each of the shot groups based on aesthetic criteria.

6. The apparatus of claim 5, wherein the aesthetic criteria is video frame information about at least one of a composition of a video frame, a color, luminance distribution, contrast, contour distribution, or blur information.

7. The apparatus of claim 2, wherein the album creator is configured to automatically arrange the ROI images of each of the shot groups in a layout area of a particular album template chosen from a plurality of previously stored album templates with different layouts.

8. The apparatus of claim 1, wherein the ROI extractor is configured to identify a position of a main subject as an ROI within the representative image, and extract the ROI image by trimming an area including the main subject to a size of a layout area in which the representative image is disposed.

9. The apparatus of claim 2, wherein the album creator is configured to keep a record in the album about video shooting date and time information.

10. The apparatus of claim 9, wherein the album creator is configured to further record information about a video shooting location.

11. A method of managing a representative video image, comprising:
dividing a video image into shot groups;
extracting a representative image from each of the shot groups; and
generating region-of-interest (ROI) images for each of the shot groups by editing the extracted representative image of each of the shot groups, focusing on an ROI within the representative image of each of the shot groups.

12. The method of claim 11, further comprising:
creating an album by arranging the extracted ROI images for each of the shot groups in an album template.
